(19) United States
(12) Patent Application Publication
(10) Pub. No.: US 2010/0262417 A1
(43) Pub. Date: Oct. 14, 2010

(54) BINARY VALUE INPUT/OUTPUT PROCESSING APPARATUS AND METHOD

(76) Inventors: Hojoon Park, Daejeon-city (KR); Jaemyoung Kim, Daejon (KR)

Correspondence Address: STAAS & HALSEY LLP, SUITE 700, 1201 NEW YORK AVENUE, N.W., WASHINGTON, DC, 20005, US

(21) Appl. No.: 12/808,299

(22) PCT Filed: Sep. 3, 2008
(86) PCT No.: PCT/KR08/05180

§ 371 Date: Jun. 15, 2010

(30) Foreign Application Priority Data
Dec. 17, 2007 (KR) 10-2007-0131977

(51) Int. Cl. G06F 9/455

(52) U.S. Cl. 703/28; 703/23

(57) ABSTRACT

The invention relates to a binary value input/output processing apparatus and method for automatically inputting binary values. A binary value that is inputted first is temporarily stored in a buffer. When a symbol indicating a binary value, such as “0x” or “0X”, is detected from the next input character string, the binary value stored in the buffer is automatically outputted to the screen, following the symbol. Then, a user selects to output, to the output device, the binary value automatically outputted to the screen or to output a new binary value to the output device, instead of the binary value. When the new binary value is outputted, the binary value stored in the buffer is deleted, and the new binary value is stored in the buffer.

### TECHNICAL FIELD

The present invention relates to an input/output processing apparatus and method for processing the input of binary values, such as a binary address, and more particularly, to a technique for processing the input of binary values in an emulator that is used to develop embedded software. This work was supported by the IT R&D program of MIC/IITA [2006-S-038-02, Development of Device-Adaptive Embedded Operating System for Mobile Convergence Computing].

### BACKGROUND ART

A basic and essential factor to develop an embedded system is terminal emulation through a serial port that connects a host PC and a target machine. When flow control is not performed, only three lines, such as a transmitting line (Tx), a receiving line (Rx), and a ground wire (Ground), are needed to perform communication through the serial port. This communication is stable in a high noise environment, and does not require a separate control device. Therefore, in a development environment of an embedded system in which the connection between the host PC and the target machine is important, a basic component is the connection of the serial port. In order to develop one embedded system, the following are needed: a boot-loader that controls the initial installation of an OS; a kernel which is a core system of the OS; a file system where files are located; and a storage device that stores setup information of the embedded system. In most of the embedded system, these are not stored in a disk device as in a PC, but are stored in a flash memory in the form of binary images.

Therefore, in the embedded systems, for example, the boot-loader, the OS, and the file system are positioned at specific addresses in the memory, not in the disk. Therefore, in order to fetch the binary images, it is necessary to download the binary images through a network or serial connection and then record them to binary memory addresses.

In order to download specific binary images to the memory, components, such as a start address, an end address, and the size of the binary image, are needed. The positions and sizes of these components depend on the type of embedded system, and these factors may have different positions in the same system according to the development environment.

The format of addresses indicating specific positions in the memory depends on the type of embedded system, but generally, the address is represented by 32 bits. According to the hexadecimal number system in the C language, an address value is represented by “0xabcd1234”, in which 8 hexadecimal digits are arranged after 0x or 0X.

For example, a command “flash 0xc8000000 0x30000000 0x01000000” for downloading the binary image and recording it on a flash memory means to record an image that has a size of 0x01000000 and is at an address 0xc8000000 on the flash memory that is at an address 0x30000000. In this case, a developer should record or memorize the binary addresses, and then manually input the binary addresses to create an instruction word. Therefore, flash memory errors or recording errors may occur due to user input errors.

Meanwhile, as a known technique for automatically inputting a specific character string, a macro function has been proposed which enables a user account and a password to be automatically inputted instead of the user manually inputting thereof, when character strings “login:” and “password:” are inputted during a login process in the Unix system. In addition, a terminal emulator that represents a specific character string using a regular expression to reinforce the macro function has also been proposed. In addition, a method of storing a binary address in a macro and fetching the stored binary address using a specific shortcut key has been used.

### DISCLOSURE

### Technical Problem

The Unix system technique that automatically inputs the user account or the password is not applicable to automatically input binary addresses. As described above, since various instruction words as well as the instruction word “flash” require the binary addresses, the method of automatically inputting only a specific character string according to the related art cannot be used to input the binary addresses in the embedded system development environment. In addition, an instruction word request is not transmitted from the target machine to the host PC, but the developer should manually input the instruction word. Therefore, in the embedded system development environment, it is unknown when the address should be inputted. For this reason, the method of automatically inputting a character string at a specific point of time, such as login, in the Unix system is not applicable for the input of binary addresses.

Further, the reinforced macro function according to the related art is available only when a specific character string is inputted from the target machine to the host PC. Therefore, the macro function cannot be used to the system in which the user inputs the binary address.

Furthermore, in the macro function using a specific shortcut according to the related art, a combination of binary addresses should be made into a macro, and a separate table for storing a plurality of macros is needed due to characteristics of the embedded system.

An object of the invention is to provide a binary value input/output processing apparatus and method capable of automatically inputting binary values that are frequently input at any time. Another object of the invention is to provide an emulator and an emulation method capable of automatically inputting binary addresses in a general development environment of an embedded system.

### Technical Solution

In order to achieve the above objects, according to an aspect of the invention, there is provided an emulator for transmitting a binary value inputted from an input device to an output device to be emulated. The emulator includes: a line buffer that stores character strings inputted from the input device in the unit of line; an input analyzer that detects the input of line feed characters from the input device; and a line buffer analyzer that, when the input of the line feed characters is detected, stores, in a binary value buffer, the binary value in the character string that is stored in the line buffer, and transmits the character string stored in the line buffer to the output device.

When the input analyzer detects a binary value specifying symbol indicating that subsequent input data is a binary value, the line buffer analyzer automatically stores, in the line buffer, the binary value stored in the binary value buffer.

In order to achieve the above objects, according to another aspect of the invention, a binary value input/output processing apparatus includes: a binary value detecting unit that detects a binary value specifying symbol indicating that subsequent input data is a binary value and a binary value that is inputted subsequent to the binary value specific symbol, from the character strings inputted from an input device; a binary value storage unit that stores the detected binary value specifying symbol and the detected binary value; and a binary value output unit that, when the binary value specifying symbol is inputted, outputs the binary value stored in the binary value storage unit to an output device together with the binary value specifying symbol.

In order to achieve the above objects, according to still another aspect of the invention, there is provided a binary value input/output processing apparatus for outputting a binary value inputted from an input device to an output device. The apparatus includes: a binary value detecting unit that detects the binary value inputted from the input device; a binary value storage unit that stores the detected binary value; and a binary value output unit that detects the input of a binary value specifying symbol indicating that subsequent input data is a binary value, and outputs the binary value stored in the binary value storage unit to the output device.

In order to achieve the above objects, according to yet another aspect of the invention, a binary value input/output processing method includes the steps of: (a) detecting a binary value specifying symbol indicating that subsequent input data is a binary value and a binary value that is inputted subsequent to the binary value specifying symbol, from a character string inputted from an input device; (b) storing the detected binary value specifying symbol and the detected binary value in a buffer; (c) when the input of the binary value specifying symbol is detected, automatically outputting the binary value stored in the buffer on a screen, following the binary value specifying symbol; and (d) when a transmission instruction character for the binary value automatically outputted to the screen is inputted, outputting, to the output device, the binary value outputted to the screen, and when another binary value is inputted instead of the binary value automatically outputted to the screen, outputting the another binary value to the output device.

### ADVANTAGEOUS EFFECTS

According to the invention, the binary value input/output processing apparatus can automatically input binary values that are frequently input at any time without storing the binary values. Further, according to the invention, it is possible to provide an emulator and an emulation method capable of automatically inputting binary addresses in a general embedded system development environment.

### DESCRIPTION OF DRAWINGS

FIG. 1 is a diagram illustrating the structure of a binary value input/output processing apparatus according to an embodiment of the invention.

FIG. 2 is a diagram illustrating the detailed structure of an emulator that automatically inputs binary value according to an embodiment of the invention.

FIG. 3 is a flowchart illustrating a process of automatically detecting input binary values and storing the binary values in a binary value buffer according to an embodiment of the invention.

FIG. 4 is a flowchart illustrating a process of inserting binary values stored in a binary value buffer into a line buffer according to an embodiment of the invention.

### BEST MODE

Hereinafter, exemplary embodiments of the invention will be described with reference to the accompanying drawings.

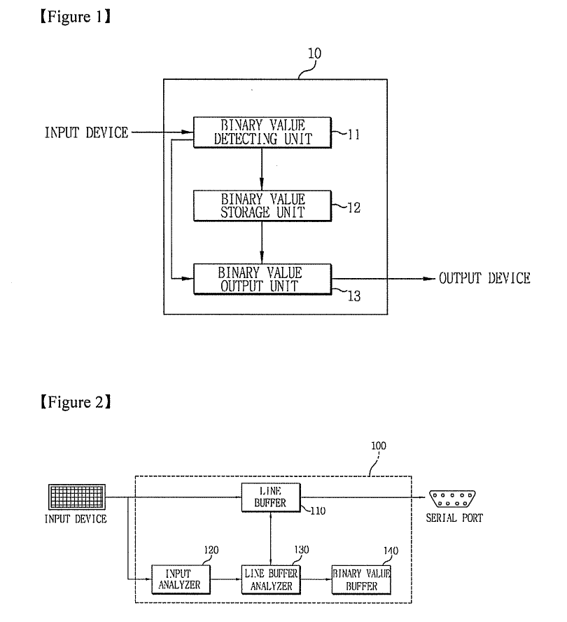

FIG. 1 is a functional block diagram illustrating a binary value input/output processing apparatus 10 according to an embodiment of the invention. FIG. 2 is a diagram illustrating the detailed structure of an emulator 100, which is an example of the binary value input/output processing apparatus 10, that transmits key inputs from an input device, such as a keyboard, to a serial port. The binary value input/output processing apparatus 10 includes a binary value detecting unit 11 that detects a binary value from a character string inputted to the input device, a binary value storage unit 12 that stores the detected binary value, and a binary value output unit 13 that transmits the binary values stored in the binary value storage unit 12 according to the detection result by the binary value detecting unit 11 to the output device.

For example, a line buffer 110 and an input analyzer 120 shown in FIG. 2 may correspond to the binary value detecting unit 11 shown in FIG. 1, and a binary value buffer 140 shown in FIG. 2 may correspond to the binary value storage unit 12 shown in FIG. 1. The line buffer 110, the input analyzer 120, and a line buffer analyzer 130 shown in FIG. 2 may correspond to the binary value output unit 13 shown in FIG. 1. The output device is a target machine for developing an embedded system, such as a mobile phone. Therefore, the binary value input/output processing apparatus 10 operates as an emulator 100 for emulating the target machine. The function of the emulator 100 may be executed by a computer program installed in a host PC, or it may be executed by an emulation apparatus that is separately installed from the host PC.

In FIG. 2, the line buffer 110 stores character strings inputted from the input device in the unit of line. The character strings stored in the line buffer 110 are sequentially displayed on a screen to be viewed by a user, and the character strings stored in the line buffer 110 are transmitted to the serial port by the input of transmission instruction characters (for example, characters “Enter”). The input analyzer 120 detects line feed characters (for example “Enter”) inputted from the input device, and transmits the detection result to the line buffer analyzer 130. In addition, the input analyzer 120 detects a binary value specifying symbol from the character strings inputted from the input device, and transmits the detection result to the line buffer analyzer 130. In this embodiment, since instruction words are processed in the unit of line, the line feed characters are identical with transmission instruction characters, which will be described below. That is, since one line is completely processed by linefeed, the input of line feed characters is the input of an instruction to transmit an instruction word for the line.

In this embodiment, the binary value specifying symbol means a symbol indicating that a subsequent character string is a binary value. For example, combinations of FIG. 0 and alphabet X, such as “0x” and “0X”, are used as the binary value specifying symbol.

The line buffer analyzer 130 receives the line feed characters detected by the input analyzer 120, and extracts a binary address included in the character strings stored in the line buffer 110. The line buffer analyzer 130 stores the extracted binary address in the binary value buffer 140.

All the binary addresses existing in one line are sequentially stored in the binary value buffer 140. For example, an instruction word “load 0xa8000000 0x00400000 0x001c0000” is inputted and stored in the line buffer 110. Then, when “Enter” is inputted, the line buffer analyzer 130 extracts a binary address “0xa8000000 0x00400000 0x001c0000” from the line buffer 110, and stores the extracted binary address in the binary value buffer 140.

In this state, when a character string “load 0x” is sequentially input again, the input analyzer 120 detects a binary value specifying symbol “0x”, and transmits the detection result to the line buffer analyzer 130. The line buffer analyzer 130 automatically stores a binary address “0xa8000000 0x00400000 0x001c0000” stored in the binary value buffer 140 in the line buffer 110, and displays a character string “load 0xa8000000 0x00400000 0x001c0000” to the user.

When a transmission instruction character (for example, characters “Enter”) is inputted from the input device, the line buffer analyzer 130 transmits, to the serial port, a character string including the binary address automatically stored in the line buffer 110. However, when characters (for example, characters “Backspace”) for canceling the input of the binary address is inputted from the input device, the input analyzer 120 detects the cancellation characters, and transmits the detection result to the line buffer analyzer 130. The line buffer analyzer 130 deletes the binary value that has been automatically input to the line buffer 110.

Then, when a new binary value and transmission instruction characters are inputted from the input device, the input analyzer 120 detects the inputted binary value and transmission instruction characters, and an instruction word including the new binary value is stored in the line buffer 110. The line buffer analyzer 130 transmits the new binary value stored in the line buffer 110 to the serial port. The line buffer analyzer 130 deletes the previous binary value “0xa8000000 0x00400000 0x001c0000” from the binary value buffer 140, and stores the new binary value in the binary value buffer 140.

Meanwhile, in this embodiment, before the binary value is transmitted, the binary value is displayed on the screen to be viewed by the user. However, at the same time when the binary value specifying symbol is detected, the binary value stored in the binary value buffer may be transmitted to the output device together with the instruction word.

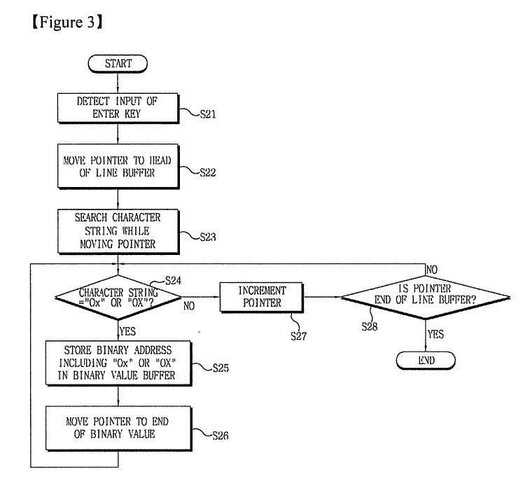

FIG. 3 is a flowchart illustrating a process of detecting the binary value from the line buffer 110 and storing the detected binary value in the binary value buffer 140 according to this embodiment.

The input analyzer 120 detects the input of an enter key (S21). The detection of the enter key means that the character string of the previous line has been transmitted to the output device and a new input character string has begun to be stored in the line buffer 110.

Therefore, when the enter key is detected in Step S21, the line buffer analyzer 130 moves a pointer to the head of the line buffer 110 (S22), and searches the character strings stored in the line buffer 110 while moving the pointer (S23).

When “0x” or “0X” is detected among the character strings (S24), the binary address stored in the line buffer 110 is stored in the binary value buffer 140 after “0x” or “0X” is stored (S25).

Since other binary addresses may be stored in the line buffer 110 after the above binary address, the line buffer analyzer 130 moves the pointer to the end of the binary value stored in the binary value buffer 140 in Step S25 (S26), and starts to search the character string again in Step S24.

When the detection result in Step S24 is “No”, the line buffer analyzer 130 increases the pointer (S27). As a result, when the pointer points to the end of the line buffer 110, the process ends in this embodiment. On the other hand, when the pointer does not point to the end of the line buffer 110, the process returns to Step S24 to search the character string again.

According to the flowchart illustrated in FIG. 3, all of the binary values existing in one line are stored in the binary value buffer 140.

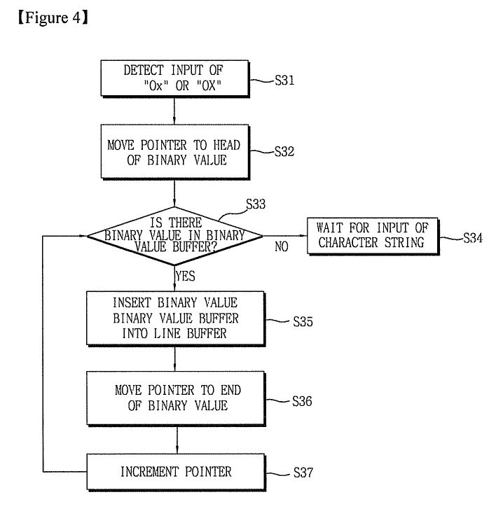

FIG. 4 is a flowchart illustrating a process of inserting the binary value stored in the binary value buffer 140 into the line buffer 110.

First, the input of “0x” or “0X” is detected (S31). When the input of “0x” or “0X” is detected, the line buffer analyzer 130 moves the pointer to the head of the binary value buffer 140 (S32). Then, the line buffer analyzer 130 determines whether there is a binary value in the binary value buffer 140 (S33). When it is determined that there is no binary value, the line buffer analyzer 130 waits for the input of the subsequent character string (S34). Therefore, when no binary value is stored in the binary value buffer 140, a binary value that is inputted subsequent to “0x” or “0X” is inserted into the line buffer 110, and then transmitted to the output device.

When it is determined in Step S33 that there is a binary value in the binary value buffer 140, the line buffer analyzer 130 inserts the binary value into the line buffer 110 (S35). Then, the line buffer analyzer 130 moves the pointer to the end of the binary value inserted into the line buffer 110 in Step S35 (S36), and performs the process again, starting from Step S33, while increasing the pointer (S37).

According to the flowchart illustrated in FIG. 4, the binary value stored in the binary value buffer 140 is inserted into the line buffer 110. The binary value inserted into the line buffer 110 is displayed on the screen subsequent to the related instruction word. When the user inputs transmission instruction characters, the binary value inserted into the line buffer 110 is transmitted to the output device. However, when the user deletes the binary value displayed on the screen and inputs a new binary value, the new binary value is stored in the line buffer 110 and then transmitted to the output device. In this case, the binary value stored in the binary value buffer 140 is deleted, and the new binary value is stored in the binary value buffer 140.

The invention includes a recording medium including a computer program that allows a computer to execute the binary value input/output processing method according to the invention. While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. An emulator for transmitting a binary value inputted from an input device to an output device to be emulated, the emulator comprising:
a line buffer that stores character strings inputted from the input device in the unit of line;
an input analyzer that detects the input of line feed characters from the input device; and
a line buffer analyzer that, when the input of the line feed characters is detected, stores, in a binary value buffer, the binary value in the character string that is stored in the line buffer, and transmits the character string stored in the line buffer to the output device,
wherein, when the input analyzer detects a binary value specifying symbol indicating that subsequent input data is a binary value, the line buffer analyzer automatically stores, in the line buffer, the binary value stored in the binary value buffer.

2. The emulator of claim 1,
wherein, when the binary value specifying symbol is detected by the input analyzer, the line buffer analyzer displays the binary value that is automatically stored in the line buffer on a screen to be viewed by a user, and
when transmission instruction characters are detected by the input analyzer, the line buffer analyzer transmits the binary value automatically stored in the line buffer to the output device.

3. The emulator of claim 1,
wherein, when the binary value specifying symbol is detected by the input analyzer, the line buffer analyzer displays the binary value that is automatically stored in the line buffer on a screen to be viewed by a user, and
when the input analyzer detects the input of another binary value and transmission instruction characters instead of the binary value that is automatically stored in the line buffer, the line buffer analyzer stores the another binary value in the line buffer, and transmits the another binary value from the line buffer to the output device.

4. The emulator of claim 3,
wherein the line buffer analyzer deletes the binary value stored in the binary value buffer, and stores the another binary value in the binary value buffer.

5. The emulator of claim 1,
wherein, when another binary value different from the binary value stored in the binary value buffer is stored in the line buffer, the line buffer analyzer deletes the binary value stored in the binary value buffer, and stores the another binary value stored in the line buffer in the binary value buffer.

6. A binary value input/output processing apparatus comprising:
a binary value detecting unit that detects a binary value specifying symbol indicating that subsequent input data is a binary value and a binary value that is inputted subsequent to the binary value specific symbol, from character strings inputted from an input device;
a binary value storage unit that stores the detected binary value specifying symbol and the detected binary value; and
a binary value output unit that, when the binary value specifying symbol is inputted, outputs the binary value stored in the binary value storage unit to the output device together with the binary value specifying symbol.

7. The binary value input/output processing apparatus of claim 6,
wherein, before outputting the binary value stored in the binary value storage unit to the output device, the binary value output unit displays the binary value to a user, and
when the input of transmission instruction characters is detected, the binary value output unit outputs the binary value stored in the binary value storage unit to the output device.

8. The binary value input/output processing apparatus of claim 6,
wherein, before outputting the binary value stored in the binary value storage unit to the output device, the binary value output unit displays the binary value to a user, and
when another binary value is inputted instead of the binary value stored in the binary value storage unit, the binary value output unit outputs the another binary value to the output device together with the binary value specifying symbol.

9. The binary value input/output processing apparatus of claim 8,
wherein the binary value storage unit deletes the previously stored binary value, and stores the another binary value.

10. The binary value input/output processing apparatus of claim 6,
wherein the binary value detecting unit detects the binary value specifying symbol and the binary value in the unit of line from the character string, and
the binary value storage unit stores one or more binary value specifying symbols and one or more binary values detected from one line.

11. The binary value input/output processing apparatus of claim 6, further comprising:
an emulator that emulates the output device,
wherein the output device is a target machine for developing an embedded system.

12. The binary value input/output processing apparatus of claim 11,
wherein the emulator is connected to the output device through a serial port.

13. A binary value input/output processing apparatus for outputting a binary value inputted from an input device to an output device, the apparatus comprising:
a binary value detecting unit that detects the binary value inputted from the input device;
a binary value storage unit that stores the detected binary value; and
a binary value output unit that detects the input of a binary value specifying symbol indicating that subsequent input data is a binary value, and outputs the binary value stored in the binary value storage unit to the output device.

14. The binary value input/output processing apparatus of claim 13,
wherein, before outputting the binary value stored in the binary value storage unit to the output device, the binary value output unit displays the binary value to a user, and
when the input of transmission instruction characters is detected, the binary value output unit outputs the binary value stored in the binary value storage unit to the output device.

15. The binary value input/output processing apparatus of claim 13,
wherein, before outputting the binary value stored in the binary value storage unit to the output device, the binary value output unit displays the binary value to a user, and
when another binary value is inputted instead of the binary value stored in the binary value storage unit, the binary value output unit outputs another binary value to the output device together with the binary value specifying symbol.

16. The binary value input/output processing apparatus of claim 15,
wherein the binary value storage unit deletes the previously stored binary value, and stores the another binary value.

17. The binary value input/output processing apparatus of claim 13,
wherein the input device can input the binary values in the unit of line, and
the binary value storage unit stores one or more binary value specifying symbols and one or more binary values detected from one input line.

18. The binary value input/output processing apparatus of claim 13,
wherein the binary value specifying symbol is a combination of FIG. 0 and alphabet X (including uppercase and lowercase).

19. A binary value input/output processing method comprising:
detecting a binary value specifying symbol indicating that subsequent input data is a binary value and a binary value that is inputted subsequent to the binary value specifying symbol, from a character string inputted from an input device;
storing the detected binary value specifying symbol and the detected binary value in a buffer;
when the input of the binary value specifying symbol is detected, automatically outputting the binary value stored in the buffer on a screen, following the binary value specifying symbol; and
when transmission instruction characters for the binary value automatically outputted to the screen is inputted, outputting, to the output device, the binary value outputted to the screen, and when another binary value is inputted instead of the binary value automatically outputted to the screen, outputting another binary value to the output device.

20. The binary value input/output processing method of claim 19,
wherein, in the outputting, when the another binary value is outputted to the output device, the binary value stored in the buffer is deleted, and the another binary value is stored in the buffer.
